(19) United States
(12) Patent Application Publication
(10) Pub. No.: US 2025/0269537 A1
(43) Pub. Date: Aug. 28, 2025

(54) EMBODIED INTELLIGENCE-BASED METHOD, APPARATUS, DEVICE AND MEDIUM FOR INDUSTRIAL PART SORTING PROCESSING

(71) Applicant: BEIHANG UNIVERSITY, Beijing (CN)

(72) Inventors: Lei REN, Beijing (CN); Jiabao Dong, Beijing (CN)

(21) Appl. No.: 18/770,252

(22) Filed: Jul. 11, 2024

(30) Foreign Application Priority Data
Feb. 27, 2024 (CN) 202410211078.1

(51) Int. Cl. B25J 9/16; G05B 19/4155; G06F 40/289; G06T 7/73; G06V 10/42; G06V 10/44; G06V 10/764

(52) U.S. Cl. CPC B25J 9/1697; B25J 9/163; B25J 9/1658; B25J 9/1666; G05B 19/4155; G06T 7/73; G06V 10/42; G06V 10/44; G06V 10/764; G05B 2219/40269; G06F 40/289; G06T 2207/10024; G06T 2207/10028; G06T 2207/20084; G06T 2207/30108; G06V 2201/06

(57) ABSTRACT

The present application provides an embodied intelligence-based method and apparatus, a device and a medium for industrial part sorting processing. In this solution, firstly, a control signal for controlling a robotic arm to sort to-be-sorted parts is obtained by a task instruction understanding model based on part sorting description information inputted by a user, and then analysis processing is performed on an image of a to-be-sorted part by an intelligent perception model for parts according to the control signal to obtain a category and a grasp pose of the to-be-sorted part, the image being collected by an industrial camera. Finally, under obstacle-avoidance processing of an intelligent obstacle-avoidance neural network model, the robotic arm is controlled to sort the to-be-sorted part based on the control signal, the category and the grasp pose of the to-be-sorted part. This method helps reducing difficulty in controlling the robotic arm simply via natural language.

### CROSS-REFERENCE TO RELATED APPLICATIONS

This application claims priority to Chinese Patent Application No. 2024102110781, filed on Feb. 27, 2024, which is hereby incorporated by reference in its entirety.

### TECHNICAL FIELD

The present application relates to the technical field of computers and, in particular, to an embodied intelligence-based method and apparatus, a device and a medium for industrial part sorting processing.

### BACKGROUND

With the continuous development of robot technology, robotic arms play an important role in the field of industrial part sorting. However, before using a robotic arm to realize a sorting task for industrial parts, it is necessary to send generated instructions for the sorting task to the robotic arm in advance.

At present, in the existing solution of generating sorting task instructions, users generally write corresponding task instruction codes for a robotic arm manually based on an actual sorting task for industrial parts, and the instruction codes are sent to the robotic arm after the writing is finished, so as to realize real-time control of the robotic arm and complete the sorting of the industrial parts.

However, in the existing solution of generating the task instructions, the users need to have high coding ability, and there is a technical problem of large difficulty in controlling the robotic arm.

### SUMMARY

The present application provides an embodied intelligence-based method and apparatus, a device and a medium for industrial part sorting processing, to solve the technical problem of large difficulty in controlling a robot in a process of using the robot to realize part sorting in the prior art.

In a first aspect, the present application provides an embodied intelligence-based method for industrial part sorting processing, which includes:
receiving part sorting description information inputted by a user, where the part sorting description information includes a feature description and a sorting requirement description of to-be-sorted parts;
performing, according to the part sorting description information, analysis processing by adopting a task instruction understanding model, to obtain a control signal for controlling a robotic arm to sort the to-be-sorted parts, where the task instruction understanding model is a neural network model which is pre-trained based on a large language model for extracting a sorting requirement from text and generating a sorting control signal based on the sorting requirement;
performing, according to the control signal, analysis processing on an image of a to-be-sorted part by adopting an intelligent perception model for parts, to obtain a category and a grasp pose of the to-be-sorted part, where the image is collected by an industrial camera, and the intelligent perception model is a neural network model which is pre-trained for determining a category and a grasp pose of a part based on image recognition analysis;
controlling the robotic arm to sort the to-be-sorted part according to the control signal, the category and the grasp pose of the to-be-sorted part, and performing obstacle-avoidance processing through an intelligent obstacle-avoidance neural network model in a sorting process.

In a possible design of the first aspect, performing the obstacle-avoidance processing through the intelligent obstacle-avoidance neural network model in the sorting process includes:
in the sorting process, processing, by adopting the intelligent obstacle-avoidance neural network model, voxel data of different angles of physical environment around the robotic arm which is collected in real time by the industrial camera, to obtain a three-dimensional spatial structure of the physical environment around the robotic arm, where the intelligent obstacle-avoidance neural network model is a pre-trained intelligent model for performing dynamic three-dimensional reconstruction according to voxel data;
processing the three-dimensional spatial structure by adopting a robotic arm kinematics model, to obtain a motion trajectory of the robotic arm;
correspondingly, controlling the robotic arm to sort the to-be-sorted part according to the control signal, the category and the grasp pose of the to-be-sorted part includes:
controlling, according to the control signal, the category and the grasp pose of the to-be-sorted part, the robotic arm to sort the to-be-sorted part following the motion trajectory of the robotic arm.

In a possible design of the first aspect, performing, according to the part sorting description information, the analysis processing by adopting the task instruction understanding model, to obtain the control signal for controlling the robotic arm to sort the to-be-sorted parts includes:
performing understanding processing on the part sorting description information through a natural language understanding portion of the task instruction understanding model to obtain a feature and a sorting requirement of the to-be-sorted parts, and generating the control signal based on the feature and sorting requirement of the to-be-sorted parts through a signal generation portion of the task instruction understanding model.

In a possible design of the first aspect, performing, according to the control signal, the analysis processing on the image of the to-be-sorted part by adopting the intelligent perception model for parts, to obtain the category and the grasp pose of the to-be-sorted part, where the image is collected by the industrial camera, includes: controlling, according to the control signal, the industrial camera to acquire the image of the to-be-sorted part, where the image includes an RGB image and a depth image;
inputting the RGB image and the depth image into the intelligent perception model for parts for performing feature analysis processing, to obtain the category and the grasp pose of the to-be-sorted part;
where the intelligent perception model for parts includes a Transformer layer, a convolutional neural network layer and a fully connected layer.

In a possible design of the first aspect, inputting the RGB image and the depth image into the intelligent perception model for parts for performing the feature analysis processing, to obtain the category and the grasp pose of the to-be-sorted part includes:
performing feature extraction on the RGB image and the depth image through the Transformer layer of the intelligent perception model for parts to obtain a global visual feature of the to-be-sorted part;
performing feature extraction on the RGB image and the depth image through the convolutional neural network layer of the intelligent perception model for parts to obtain a local visual feature of the to-be-sorted part;
determining, according to the global visual feature and the local visual feature, the category and the grasp pose of the to-be-sorted part through the fully connected layer of the intelligent perception model for parts.

In a possible design of the first aspect, in the sorting process, processing, by adopting the intelligent obstacle-avoidance neural network model, the voxel data of different angles of the physical environment around the robotic arm which is collected in real time by the industrial camera, to obtain the three-dimensional spatial structure of the physical environment around the robotic arm includes:
controlling multiple industrial cameras pre-arranged around the robotic arm to scan an activity space of the robotic arm at different angles and acquire the voxel data of different angles of the physical environment around the robotic arm; inputting the voxel data of different angles of the physical environment around the robotic arm into the intelligent obstacle-avoidance neural network model to perform feature extraction and perform three-dimensional space reconstruction according to an extracted feature, to obtain the three-dimensional space structure.

In a possible design of the first aspect, the intelligent obstacle-avoidance neural network model includes a three-dimensional convolution layer, an average pooling layer and a fully connected layer;
where the three-dimensional convolution layer is configured to extract a global visual feature of a three-dimensional space from the voxel data of different angles of the physical environment around the robotic arm;
the average pooling layer is configured to reduce a size of a voxel grid in the three-dimensional space;
the fully connected layer is configured to reconstruct a grid model with a same size as an inputted voxel grid.

In a second aspect, the present application provides an embodied intelligence-based apparatus for industrial part sorting processing, which includes:
a receiving module, configured to receive part sorting description information inputted by a user, where the part sorting description information includes a feature description and a sorting requirement description of to-be-sorted parts;
a processing module, configured to perform, according to the part sorting description information, analysis processing by adopting a task instruction understanding model, to obtain a control signal for controlling a robotic arm to sort the to-be-sorted parts, where the task instruction understanding model is a neural network model which is pre-trained based on a large language model for extracting a sorting requirement from text and generating a sorting control signal based on the sorting requirement;
where the processing module is further configured to perform, according to the control signal, analysis processing on an image of the to-be-sorted part, to obtain a category and a grasp pose of the to-be-sorted part, where the image is collected by an industrial camera, and the intelligent perception model is a neural network model which is pre-trained for determining a category and a grasp pose of a part based on image recognition analysis;
the processing module is further configured to control the robotic arm to sort the to-be-sorted part according to the control signal, the category and the grasp pose of the to-be-sorted part, and perform obstacle-avoidance processing through an intelligent obstacle-avoidance neural network model in a sorting process.

In a third aspect, the present application provides an electronic device including a processor and a memory communicatively connected with the processor;
the memory store computer-executed instructions;
the processor executes the computer-executed instructions stored in the memory, to implement the embodied intelligence-based method for industrial part sorting processing described in any one of the first aspect.

In a fourth aspect, the present application provides a computer-readable storage medium, where computer-executable instructions are stored in the computer-readable storage medium, and when the computer-executable instructions are executed by a processor, the embodied intelligence-based method for industrial part sorting processing described in any one of the first aspect is implemented.

In a fifth aspect, the present application provides a computer program product, which includes a computer program, and when the computer program is executed by a processor, the embodied intelligence-based method for industrial part sorting processing described in any one of the first aspect is implemented.

The embodied intelligence-based method, apparatus, device and medium for industrial part sorting processing provided by the present application can be used in the technical field of computers. In this solution, the control signal for controlling the robotic arm to sort the to-be-sorted parts can be obtained by the task instruction understanding model based on the part sorting description information inputted by the user, without the need for the user to write complicated instruction codes for part sorting, thus reducing the difficulty in controlling the robotic arm. The analysis processing can be performed by the intelligent perception model for parts on the image of the to-be-sorted part collected by the industrial camera, and the category and the grasp pose of the to-be-sorted part can be obtained, without having to let the part appear on an assembly line in a fixed pose and then let the robotic arm go to a fixed position to grasp it, which is beneficial to the development and promotion of an intelligent flexible production line. In the process of part sorting by the robotic arm, the obstacle-avoidance processing is performed by the intelligent obstacle-avoidance neural network model in real time, thus ensuring the safety of the robotic arm in the process of part sorting.

### BRIEF DESCRIPTION OF DRAWINGS

The accompanying drawings, which are incorporated in and constitute a part of this specification, illustrate embodiments consistent with the present application and together with the description, serve to explain the principles of the present application.

FIG. 1 is a schematic diagram of an application scenario of an embodied intelligence-based method for industrial part sorting processing provided by the present application.

FIG. 2 is a schematic flowchart of a first embodiment of an embodied intelligence-based method for industrial part sorting processing provided by the present application.

FIG. 3 is a schematic flowchart of generating a control signal based on a task instruction understanding model provided by the present application.

FIG. 4 is a schematic flowchart of a second embodiment of an embodied intelligence-based method for industrial part sorting processing provided by the present application.

FIG. 5 is a schematic flowchart of a third embodiment of an embodied intelligence-based method for industrial part sorting processing provided by the present application.

FIG. 6 is a schematic flowchart of a fourth embodiment of an embodied intelligence-based method for industrial part sorting processing provided by the present application.

FIG. 7 is a schematic flowchart of a fifth embodiment of an embodied intelligence-based method for industrial part sorting processing provided by the present application.

FIG. 8 is a schematic flowchart of a sixth embodiment of an embodied intelligence-based method for industrial part sorting processing provided by the present application.

FIG. 9 is a schematic diagram of a logical framework of an intelligent perception model for parts provided by the present application.

FIG. 10 is a schematic flowchart of a seventh embodiment of an embodied intelligence-based method for industrial part sorting processing provided by the present application.

FIG. 11 is a schematic diagram of a logical framework of an intelligent obstacle-avoidance neural network model provided by the present application.

FIG. 12 is a schematic diagram of a framework of embodied intelligence-based industrial part sorting processing provided by the present application.

FIG. 13 is a schematic structural diagram of a first embodiment of an embodied intelligence-based apparatus for industrial part sorting processing provided by the present application;

FIG. 14 is a schematic structural diagram of an embodied intelligence-based electronic device for industrial part sorting processing provided by the present application.

Through the above drawings, clear embodiments of the present application have been shown, which will be described in more detail later. These drawings and written descriptions are not intended to limit the scope of the concept of the present application in any way, but to explain the concept of the present application to those skilled in the art by referring to specific embodiments.

### DESCRIPTION OF EMBODIMENTS

Exemplary embodiments will now be explained in detail, examples of which are illustrated in the accompanying drawings. When the following description refers to the drawings, unless otherwise indicated, the same numbers in different drawings indicate the same or similar elements. The embodiments described in the following exemplary embodiments do not represent all embodiments consistent with the present application. Rather, they are merely examples of apparatuses and methods consistent with some aspects of the present application as detailed in the appended claims.

First, terms involved in the present application are explained.

Embodied intelligence: refer to the ability of an intelligent system or machine to interact with the environment in real time through perception and interaction. An embodied intelligent system usually has the ability of perception, cognition, decision-making and action, and can interact with the environment through sensors and actuators and make corresponding decisions and actions according to the change of the environment.

Large language model: refer to a deep learning model trained with a large amount of text data, and can generate natural language text or understand the meaning of the language text.

Voxel: refer to the abbreviation of volume pixel. A solid containing voxels can be represented by stereo rendering or extracting a polygon isosurface with a given threshold contour. As the smallest units of digital data in three-dimensional space segmentation, voxels are used in fields such as three-dimensional imaging, scientific data and medical images.

At present, with the development of automation and intelligence, robotic arms are gradually applied in industrial production. Among them, the technology of sorting industrial parts based on robotic arms has become a research hotspot. With the help of robotic arms, industrial parts can be automatically sorted. However, before using a robotic arm to realize a sorting task for industrial parts, it is necessary to send generated instructions for the sorting task to the robotic arm in advance.

At present, sorting task instructions sent to the robotic arm mainly rely on manual coding. Specifically, users write corresponding task instruction codes for the robotic arm manually based on an actual sorting task of industrial parts, and the instruction codes are sent to the robotic arm after the writing is finished, so as to realize real-time control of the robotic arm and complete the sorting of the industrial parts. At the same time, in the process of real-time control of the robotic arm, communication with the robotic arm is mainly in the form of Ethercat Ethernet bus or robot operating system.

However, in the existing solution of generating the task instructions, the users need to have high coding ability, and there is a technical problem of large difficulty in controlling the robotic arm. At the same time, for a part sorting task, a mainstream method in the industry at present is to let parts appear on an assembly line in a fixed pose and then let a robotic arm go to a fixed position to grasp them. This method is not universal after the layout of production line or the type of industrial parts is changed, which is not conducive to the development and promotion of an intelligent flexible production line. On this basis, the communication mode with the robotic arm is also complicated, and the learning cost of the communication control mode is high, which is prone to leading to the technical problem of large difficulty in controlling the robotic arm. In addition, for many robotic arm tasks in industrial production, the robotic arm needs to work within a limited three-dimensional space, otherwise serious safety accidents will occur if it encounters other objects or people. If an artificial intelligence algorithm is applied to the industrial robotic arm tasks, because the path of the robotic arm will not be fixed every time, it is particularly necessary to use a vision-based dynamic obstacle-avoidance method to help the robotic arm perceive the surrounding three-dimensional environment in real time to prevent collision and safely perform the industrial tasks, which results in a complicated process.

In view of the above problems, in the process of studying the method of using the robotic arm to realize the part sorting, the inventors found that it is necessary to transmit the part sorting instructions to the robotic arm in advance if it is desired to realize automatic part sorting by the robotic arm. However, at this stage, a code sequence corresponding to the part sorting instructions need to be completed by users with high coding ability. At the same time, the parts waiting to be sorted need to appear on the industrial line in a fixed pose. When a pose of a part changes, the robotic arm cannot accurately identify and grasp it. Based on this, the inventors considered whether the writing of the code sequence corresponding to the part sorting instructions can get rid of the dependence on the manual mode and whether the code sequence can be automatically generated by a network model with code sequence generation capability, and at the same time, the robotic arm can accurately identify and grasp parts with different poses. Specifically, a task instruction understanding model is designed, and this model takes part sorting description information from a user as input and a control signal for controlling a robotic arm to sort to-be-sorted parts as output, so as to realize automatic writing of a code sequence corresponding to part sorting instructions. On this basis, an intelligent perception model for parts is designed, and this model takes an image of a to-be-sorted part collected by an industrial camera as input and a category and a grasp pose of the to-be-sorted part as output, so as to realize accurate identification and grasping of parts with different poses. At the same time, a designed intelligent obstacle-avoidance neural network model is applied to ensure the safety of the sorting process in the process of the robotic arm executing a part sorting task.

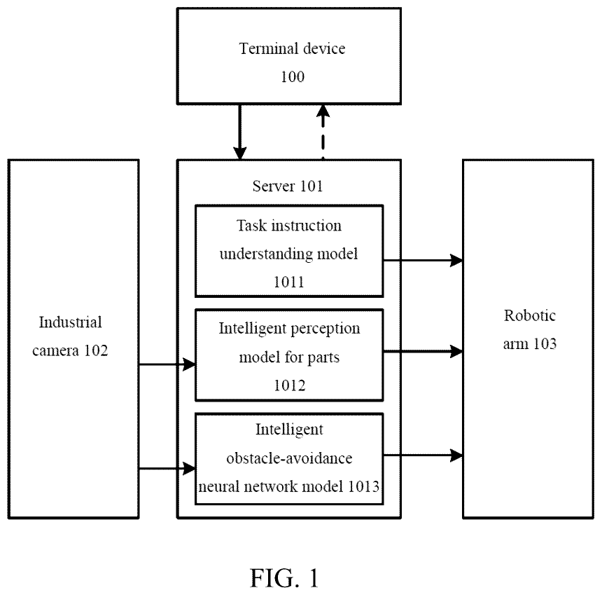

FIG. 1 is a schematic diagram of an application scenario of an embodied intelligence-based method for industrial part sorting processing provided by the present application. As shown in FIG. 1, the application scenario of solutions provided by the present application includes a terminal device 100, a server 101, an industrial camera 102 and a robotic arm 103. Among them, the server 101 is mainly used for deployment of a task instruction understanding model 1011, an intelligent perception model for parts 1012 and an intelligent obstacle-avoidance neural network model 1013.

The terminal device 100 is mainly configured to receive part sorting description information inputted by a user and transmit the information to the server 101. After the server 101 receives the part sorting description information sent by the terminal device 100, the description information is used as the input of the task instruction understanding model 1011, and a control signal for controlling the robotic arm 103 to sort to-be-sorted parts can be obtained through the task instruction understanding model 1011. The control signal will be transmitted to a perception system in the robotic arm 103 in real time, and the robotic arm 103 will start to execute a part sorting operation.

Before the robotic arm 103 executes the part sorting operation, the industrial camera 102 takes an image of a to-be-sorted part on the current industrial line, which is taken as the input of the intelligent perception model for parts 1012 in the server 101, to obtain a category and a grasp pose of the to-be-sorted part. At the same time, the industrial camera 102 photographs the physical environment around the robotic arm 103 in real time, and the corresponding environmental data is taken as the input of the intelligent obstacle-avoidance neural network model 1013 in the server 101, to obtain a motion trajectory of the robotic arm 103. Based on the control signal, the category and the grasp pose of the to-be-sorted part, the robotic arm 103 executes a sorting operation on the to-be-sorted part according to the motion trajectory.

Although only one terminal device 100, one server 101, one industrial camera 102 and one robotic arm 103 are shown in FIG. 1, it should be understood that there may be two or more terminal devices 100, servers 101, industrial cameras 102 and robotic arms 103.

The technical solutions of the present application and how the technical solutions of the present application can solve the above technical problems will be described in detail with specific embodiments. The following specific embodiments can be combined with each other, and the same or similar concepts or processes may not be repeated in some embodiments. Embodiments of the present application will be described below with reference to the accompanying drawings.

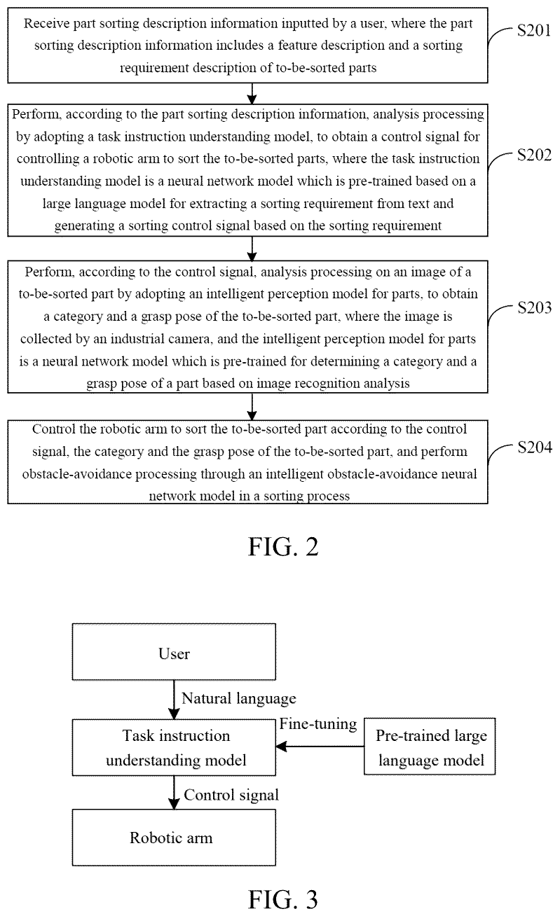

FIG. 2 is a schematic flowchart of a first embodiment of an embodied intelligence-based method for industrial part sorting processing provided by the present application. As shown in FIG. 2, a procedure of the embodied intelligence-based method for industrial part sorting processing may include the following steps.

S201: receive part sorting description information inputted by a user, where the part sorting description information includes a feature description and a sorting requirement description of to-be-sorted parts.

In this step, the user can input a preset uniform resource locator (URL) at a terminal device to enter a corresponding website, when having a request for part sorting. This website is mainly used to receive the part sorting description information inputted by the user. The preset URL is determined when the website is built, and the website is deployed in a server.

Specifically, while providing the user with a position for inputting part sorting description information, the website can receive the part sorting description information inputted by the user in real time, and will transmit the part sorting description information to a neural network model preset inside the website. The part sorting description information includes the feature description and the sorting requirement description of the to-be-sorted parts, which are formed by natural language descriptions. For example, the part description information is “sort all bearing parts into one box”.

The feature description mainly defines an attribute of the to-be-sorted parts, such as the material, use and shape of the to-be-sorted parts.

The sorting requirement description mainly refers to an instruction of where the parts are sorted, such as how many boxes the to-be-sorted parts are to be sorted into.

S202: perform, according to the part sorting description information, analysis processing by adopting a task instruction understanding model, to obtain a control signal for controlling a robotic arm to sort the to-be-sorted parts, where the task instruction understanding model is a neural network model which is pre-trained based on a large language model for extracting a sorting requirement from text and generating a sorting control signal based on the sorting requirement.

In this step, after the part sorting description information inputted by the user is received based on step S201, the neural network model deployed in the server performs analysis processing based on the part sorting description information. The neural network model deployed in the server is a task instruction understanding model.

Specifically, the task instruction understanding model is a neural network model that is pre-trained based on a large language model for extracting a sorting requirement from text and generating a sorting control signal based on the sorting requirement. The large language model is pre-trained, and will go through multiple pre-training steps in the pre-training process, including negative sampling, mask strategies and so on. In each pre-training step, the large language model will use a large amount of text data to learn the statistical structure, grammar and semantics of text, so that the large language model can better understand the relationship between words, phrases and sentences.

When inputting a natural language into the large language model, the large language model first encodes the inputted natural language into multiple word vectors, and retains contextual information between different word vectors, so as to better understand the relationship between words in a sequence and the meaning of whole-sentence text or whole-paragraph text. At the same time, the large language model uses a self-attention mechanism to deal with the close association relationship between the words and/or sentences before and after the text inputted by the user, and puts different emphasis on different words and/or sentences, so as to give a higher level of attention to key information, which enables the large language model to effectively master the dependence between the text.

After the large language model is pre-trained, the large language model needs to be fine-tuned to adapt to tasks of generating part sorting control signals. Specifically, the task instruction understanding model fine-tunes a network structure on the basis of the pre-trained large language model, and then realizes the tasks of generating the part sorting control signals. A part sorting control signal is a part sorting code sequence, which is an instruction signal for the robotic arm to execute a subsequent part sorting task.

Fine-tuning the network structure is mainly to modify the last few layers of the network structure of the large language model. Based on part types and sorting requirements involved in the part sorting tasks, the last few layers of the network structure are designed as a classification network, which extracts the part sorting requirements inputted by the user and meanwhile classifies the part sorting requirements into several specific categories of sorting tasks of the robotic arm.

In one possible implementation, the classification network adopts three fully connected layers and one Softmax classification layer. Among them, the number of nodes in the first fully connected layer is set to 4096, the number of nodes in the second fully connected layer is set to 1024, and the number of nodes in the third fully connected layer is set to 256. The Softmax classification layer is configured to classify the inputted natural language sorting requirements into categories such as “sort by material”, “sort by use”, and specific output nodes depend on the requirements.

For example, the part sorting description information is “sort all bearing parts into one box”, “sort all transparent parts into one box” and “sort all bearing and fastener parts into two boxes respectively”, etc. After receiving the above part sorting description information, the task instruction understanding model will classify these pieces of part sorting description information into 2×2 categories in the classification network of the last few layers, that is, two classification problems. The first classification problem is “sort by use of parts” or “sort by material of parts”. The second classification problem is to divide the parts into how many boxes. After the classification is completed, the task instruction understanding model combines two classification results to obtain a control signal for controlling the robotic arm to sort the to-be-sorted parts, that is, a corresponding code sequence for part sorting instructions. The control signal will be inputted to a perception system of the robotic arm to realize the sorting task for different parts.

In one possible implementation, a loss function defined in the task instruction understanding model is:

$$L ( y , \hat{y} ) = - {\sum }_{i = 1}^{N} {y}_{i} \cdot log ( \frac{exp ( {\hat{y}}_{i} )}{{\sum }_{j = 1}^{N} exp ( {\hat{y}}_{j} )} )$$

where L(y, ŷ) refers to a loss function value, i refers to the i-th category corresponding to a to-be-sorted part, j refers to the j-th category corresponding to the to-be-sorted part, N is the number of categories of the to-be-sorted part, yᵢ is an actual label, and ŷᵢ is a classification result outputted by the task instruction understanding model.

FIG. 3 is a schematic flowchart of generating a control signal based on a task instruction understanding model provided by the present application. As shown in FIG. 3, the task instruction understanding model receives a natural language inputted by a user, which is description information of to-be-sorted parts. The task instruction understanding model is obtained by fine-tuning based on the pre-trained large language model. Based on the task instruction understanding model, the natural language inputted by the user is processed, and a control signal for controlling the robotic arm to execute a part sorting task can be obtained. The control signal is transmitted to the perception system of the robotic arm in real time to control the robotic arm to execute the part sorting task.

S203: perform, according to the control signal, analysis processing on an image of a to-be-sorted part by adopting an intelligent perception model for parts, to obtain a category and a grasp pose of the to-be-sorted part, where the image is collected by an industrial camera, and the intelligent perception model for parts is a neural network model which is pre-trained for determining a category and a grasp pose of a part based on image recognition analysis.

In this step, after the task instruction understanding model deployed in the server performs the analysis processing on the part sorting description information to obtain the control signal for controlling the robotic arm to sort the to-be-sorted part based on step S202, the control signal is inputted to the perception system of the robotic arm.

After the perception system of the robotic arm receives the control signal, the part sorting task starts to be executed. In the process of executing the part sorting task, the industrial camera takes an image of each to-be-sorted part, and transmits the taken image to the intelligent perception model for parts deployed in the server in real time. The intelligent perception model for parts performs analysis processing based on the taken image of the part, and determines the category and the corresponding grasp pose of the part, so as to assist the robotic arm to realize the accurate identification and sorting of the part.

The intelligent perception model for parts is a neural network model that is pre-trained for determining a category and a grasp pose of a part based on image recognition analysis. In the intelligent perception model for parts, the input is image data corresponding to a to-be-sorted part, and the output is the category and the grasp pose of the to-be-sorted part. Based on the determined category of the to-be-sorted part, the robotic arm determines whether to grasp and sort the part in combination with the part sorting instructions. If the category of the to-be-sorted part conforms to the part category specified in the part sorting instructions, the robotic arm sorts the to-be-sorted part to a target position based on the determined grasp pose. If the category of the to-be-sorted part does not conform to the part category specified in the part sorting instructions, the robotic arm does not need to perform any operation on the part. The grasp pose is to tell the robotic arm how to grasp a part with a different position and angle accurately and stably.

S204: control the robotic arm to sort the to-be-sorted part according to the control signal, the category and the grasp pose of the to-be-sorted part, and perform obstacle-avoidance processing through an intelligent obstacle-avoidance neural network model in a sorting process.

In this step, based on the control signal for controlling the robotic arm to sort the to-be-sorted parts obtained in step S202 and the category and the grasp pose of the to-be-sorted part obtained in step S203, the robotic arm is controlled to sort the to-be-sorted part, and obstacle-avoidance processing is performed through the intelligent obstacle-avoidance neural network model in the sorting process.

The robotic arm has a built-in perception system, and the perception system specifically includes a vision system of the robotic arm and a built-in artificial intelligence model. The vision system of the robotic arm can shoot image information of each to-be-sorted part on the current industrial line, and send the image information corresponding to the to-be-sorted part to the intelligent perception model for parts in real time, so as to obtain the category and the grasp pose of the to-be-sorted part. The built-in artificial intelligence model of the robotic arm can receive the control signal and execute corresponding part sorting instructions, thus realizing real-time part sorting. At the same time, the intelligent obstacle-avoidance neural network model deployed in the server outputs the current motion trajectory of the robotic arm in real time in the process of the robotic arm executing the part sorting task, so as to realize obstacle-avoidance processing in the part sorting process to prevent the robotic arm from having safety problems in the part sorting process.

Based on the control signal, the category and the grasp pose of the current to-be-sorted part, the robotic arm determines whether the current to-be-sorted part meets the part sorting requirement involved in the control signal. For example, the part sorting requirement involved in the control signal is “sort all transparent parts into the iron box No. 3”. If the category of the current to-be-sorted part is not a transparent part, the robotic arm does not execute the sorting operation on the current part. If the category of the current to-be-sorted part is a transparent part, the robotic arm reasonably plans a grasping path based on the control signal and obstacle-avoidance processing content outputted by the intelligent obstacle-avoidance neural network model, and adopts the corresponding grasp pose during the grasping to realize the accurate grasping of the to-be-sorted part, thus completing the sorting operation of the current to-be-sorted part.

The embodied intelligence-based method for industrial part sorting processing provided by this embodiment is mainly to explain how the robotic arm realizes the process of accurately grasping the to-be-sorted part based on the control signal, the category and the grasp pose of the to-be-sorted part. The task instruction understanding model can obtain the control signal for controlling the robotic arm to sort the to-be-sorted parts based on the part sorting description information inputted by the user, and this step does not require the user to have high ability to write instruction codes for part sorting, thus reducing the difficulty in controlling the robotic arm. The intelligent perception model for parts can perform analysis processing on the image of the to-be-sorted part collected by the industrial camera, and obtain the category and the grasp pose of the to-be-sorted part, without the need for the part to appear on the industrial line in the fixed pose before being sorted, thus having high generalization. In the process of the robotic arm executing the part sorting task, the intelligent obstacle-avoidance neural network model is configured to perform the obstacle-avoidance processing, thus ensuring the safety of the robotic arm executing the part sorting task and avoiding the occurrence of safety accidents.

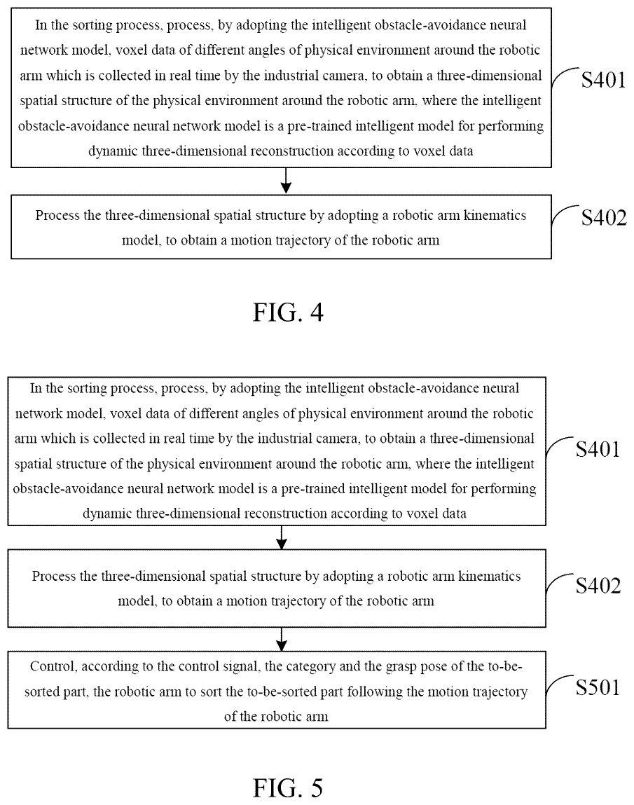

FIG. 4 is a schematic flowchart of a second embodiment of an embodied intelligence-based method for industrial part sorting processing provided by the present application. As shown in FIG. 4, on the basis of the above embodiments, obstacle-avoidance processing is performed through the intelligent obstacle-avoidance neural network model in the sorting process, and a procedure of the embodied intelligence-based method for industrial part sorting processing may include the following steps.

S401: in the sorting process, process, by adopting the intelligent obstacle-avoidance neural network model, voxel data of different angles of physical environment around the robotic arm which is collected in real time by the industrial camera, to obtain a three-dimensional spatial structure of the physical environment around the robotic arm, where the intelligent obstacle-avoidance neural network model is a pre-trained intelligent model for performing dynamic three-dimensional reconstruction according to voxel data.

In this step, the robotic arm performs the obstacle-avoidance processing through the intelligent obstacle-avoidance neural network model in the process of the robotic arm being controlled to sort the to-be-sorted part according to the control signal, the category and the grasp pose of the to-be-sorted part.

The intelligent obstacle-avoidance neural network model is deployed in the server, and is a pre-trained intelligent model for performing dynamic three-dimensional reconstruction according to the voxel data. The input is mainly the voxel data of the to-be-sorted part.

Specifically, the collection of the voxel data mainly depends on the real-time collection of industrial cameras, that is, multiple industrial cameras are arranged at different angles around the robotic arm. The type of the industrial camera is not limited, as long as the camera has the function of acquiring the voxel data corresponding to the to-be-sorted part. The voxel is the abbreviation of volume pixel, and a solid containing voxels can be represented by stereo rendering or extracting a polygon isosurface with a given threshold contour. As the smallest units of digital data in three-dimensional space segmentation, voxels are mainly used in fields such as three-dimensional imaging, scientific data and medical images. In the process of the robotic arm executing the part sorting task, multiple industrial cameras collect the voxel data of the physical environment around the robotic arm from different angles in real time, and transmit multiple pieces of voxel data that is acquired to the intelligent obstacle-avoidance neural network model deployed in the server in real time.

After receiving the multiple pieces of voxel data, the intelligent obstacle-avoidance neural network model processes these voxel data to obtain a three-dimensional structure of the physical environment around the robotic arm.

For example, robotic arm A is executing the part sorting task, and three industrial cameras are arranged around the robotic arm A, namely industrial camera 1, industrial camera 2 and industrial camera 3. These three industrial cameras can completely cover the physical environment around the robotic arm A. The physical environment covered by industrial camera 1 is area 1, the physical environment covered by industrial camera 2 is area 2, and the physical environment covered by industrial camera 3 is area 3. The area 1, the area 2 and the area 3 constitute the physical environment around the robotic arm A together. In the process of the robotic arm A executing the part sorting task, respective industrial cameras collect voxel data of the physical environment around the robotic arm A from different angles in real time, and transmit them to the intelligent obstacle-avoidance neural network model deployed in the server. After processing by the multi-layer network in the neural network model, the three-dimensional spatial structure of the physical environment around the robotic arm A can be obtained, and then the three-dimensional reconstruction of the physical environment around the robotic arm A can be realized.

S402: process the three-dimensional spatial structure by adopting a robotic arm kinematics model, to obtain a motion trajectory of the robotic arm.

In this step, based on step S401, in the part sorting process, the intelligent obstacle-avoidance neural network model is adopted to process the voxel data of different angles of the physical environment around the robotic arm collected in real time by the industrial camera to obtain the three-dimensional spatial structure of the physical environment around the robotic arm. After that, the three-dimensional spatial structure is processed in combination with the robotic arm kinematic model to obtain the motion trajectory of the robotic arm.

The robotic arm kinematics model can be deployed in the server or within the artificial intelligence model in the perception system of the robotic arm in advance. The specific deployment position is determined according to an actual situation. The robotic arm kinematics model is a model to study the motion law of the robotic arm. In the process of studying, it is necessary to determine the pose of the robotic arm, that is, to determine the position and attitude of an end effector of the robotic arm in the three-dimensional space. Generally, the relationship between joints of the robotic arm is described using coordinate transformation technology.

Specifically, after obtaining the three-dimensional spatial structure of the physical environment around the robotic arm based on the intelligent obstacle-avoidance neural network model, data information corresponding to the three-dimensional spatial structure is transmitted to the robotic arm kinematics model in real time, and the kinematics model can process the three-dimensional spatial structure of the environment around the robotic arm to obtain the motion trajectory of the robotic arm.

The embodied intelligence-based method for industrial part sorting processing provided by this embodiment is mainly to explain the process of how the robotic arm performs obstacle-avoidance processing through the intelligent obstacle-avoidance neural network model in the part sorting process. The intelligent obstacle-avoidance neural network model can process the voxel data of different angles of the physical environment around the robotic arm collected by the industrial cameras, to obtain the three-dimensional spatial structure of the physical environment around the robotic arm in real time. Combined with the three-dimensional spatial structure, the motion trajectory of the robotic arm can be obtained by the robotic arm kinematics model, thus ensuring the safety of the robotic arm in the part sorting process and avoiding the occurrence of safety accidents.

FIG. 5 is a schematic flowchart of a third embodiment of an embodied intelligence-based method for industrial part sorting processing provided by the present application. As shown in FIG. 5, on the basis of any one of the above embodiments, the robotic arm is controlled to sort the to-be-sorted part according to the control signal, the category and the grasp pose of the to-be-sorted part, and a procedure of the embodied intelligence-based method for industrial part sorting processing may include the following steps.

S501: control, according to the control signal, the category and the grasp pose of the to-be-sorted part, the robotic arm to sort the to-be-sorted part following the motion trajectory of the robotic arm.

In this step, after the motion trajectory of the robotic arm is obtained based on step S402, the perception system of the robotic arm controls the robotic arm to sort the to-be-sorted part following the motion trajectory of the robotic arm, according to the control signal, the category and the grasp pose of the to-be-sorted part.

The robotic arm safely sorts the to-be-sorted part to the required position according to the motion trajectory. For example, for the part to be sorted, the determined motion trajectory of the robotic arm is as follows: the robotic arm opening a gripper thereof, the robotic arm running from an initial state to a grasping state, the robotic arm closing the gripper, the robotic arm running from the grasping state to a sorting destination, the robotic arm opening the gripper, and the robotic arm running from the sorting destination to the initial state.

The embodied intelligence-based method for industrial part sorting processing provided by this embodiment is mainly to explain conditions on which the robotic arm depends in the process of executing the part sorting task. Under the premise of the control signal, the robotic arm determines whether to grasp the part based on the category of the to-be-sorted part, and after it is determined to grasp, the grasping operation is performed with the motion trajectory of the robotic arm and the grasp pose, thus the safety of the part grasping process is ensured, and all the to-be-sorted parts are safely sorted to different target positions according to the requirements of categories and the like.

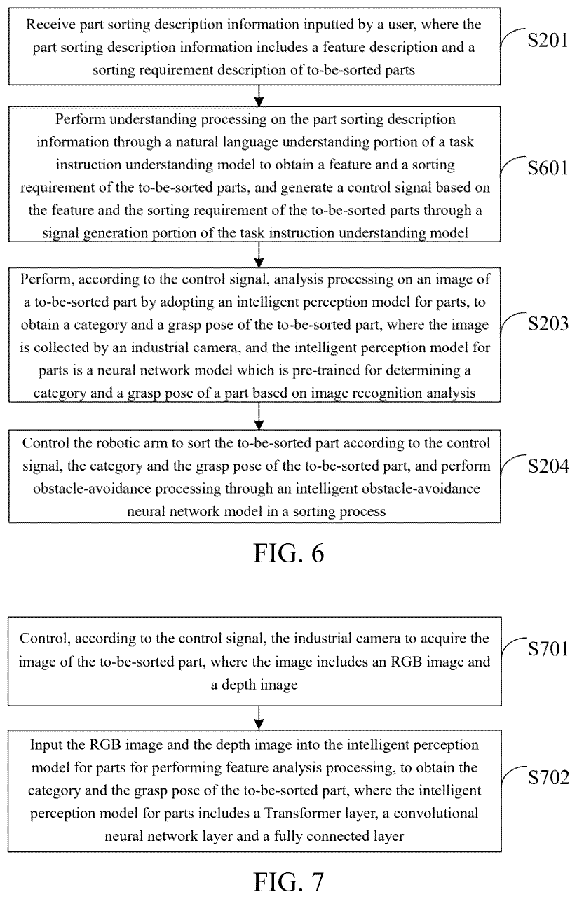

FIG. 6 is a schematic flowchart of a fourth embodiment of an embodied intelligence-based method for industrial part sorting processing provided by the present application. As shown in FIG. 6, on the basis of any one of the above embodiments, according to the part sorting description information, the analysis processing is performed by adopting the task instruction understanding model, to obtain the control signal for controlling the robotic arm to sort the to-be-sorted parts, and a procedure of the embodied intelligence-based method for industrial part sorting processing may include the following steps.

S601: perform understanding processing on the part sorting description information through a natural language understanding portion of the task instruction understanding model to obtain a feature and a sorting requirement of the to-be-sorted parts, and generate the control signal based on the feature and the sorting requirement of the to-be-sorted parts through a signal generation portion of the task instruction understanding model.

In this step, the control signal outputted by the task instruction understanding model deployed in the server to the perception system of the robotic arm is mainly generated with the help of the natural language understanding portion and the signal generation portion of the task instruction understanding model.

The task instruction understanding model can be divided into the natural language understanding portion and the signal generation portion according to a functional division. Specifically, the natural language understanding portion takes the part sorting description information inputted by the user as input, and takes the feature and the sorting requirement of the to-be-sorted parts as output. For example, the part sorting description information inputted by the user is “sort all round parts to the target box No. 1”, so the natural language understanding portion of the task instruction understanding model takes the natural language “sort all round parts to the target box No. 1” as input, and after processing by a neural network involved in the natural language understanding portion, the corresponding feature and sorting requirement of the to-be-sorted parts in the part sorting description information can be obtained, that is, the feature of the to-be-sorted parts is a round part, and the sorting requirement is to sort to the target box No. 1.

After the feature and the sorting requirement of the to-be-sorted parts are obtained in the natural language understanding portion, this portion of content is taken as the input of the signal generation portion of the task instruction understanding model. After processing by a neural network involved in the signal generation portion, a control signal can be obtained. The control signal corresponds to the feature and the sorting requirement of the to-be-sorted parts and is a sequence of sorting instruction codes. This sequence of sorting instruction codes will be sent to the perception system of the robotic arm as a control signal to control the robotic arm to execute the sorting operation on the to-be-sorted parts according to the feature and the sorting requirements of the to-be-sorted parts involved in the part sorting description information. For example, the control signal obtained through the signal generation portion of the task instruction understanding model is: for example, the sorting requirement is “sort by material of parts”, and the task instruction understanding model calls a portion of the model that extracts a part material feature, outputs a part material classification result, and generates a control signal corresponding to the part material classification result on this basis. For another example, if the sorting requirement is “sort by use of parts”, the task instruction understanding model calls a portion of the model that extracts a part use feature, outputs a part use classification result, and generates a control signal corresponding to the part use classification result on this basis.

The embodied intelligence-based method for industrial part sorting processing provided by this embodiment is mainly to explain in detail how the task instruction understanding model obtains the control signal based on the part sorting description information. The natural language understanding portion of the task instruction understanding model can automatically generate the corresponding feature and sorting requirement information of the to-be-sorted parts through the part sorting description information inputted by the user, and the signal generation portion of the task instruction understanding model takes the output of the natural language understanding portion as the input to obtain the control signal for controlling the robotic arm. The control signal does not need to be generated manually, but automatically generated by means of the neural network model, thus reducing the difficulty in controlling the robotic arm.

FIG. 7 is a schematic flowchart of a fifth embodiment of an embodied intelligence-based method for industrial part sorting processing provided by the present application. As shown in FIG. 7, on the basis of any one of the above embodiments, according to the control signal, the analysis processing is performed by adopting the intelligent perception model for parts on the image of the to-be-sorted part collected by the industrial camera, to obtain the category and the grasp pose of the to-be-sorted part, and a procedure of the embodied intelligence-based method for industrial part sorting processing may include the following steps.

S701: control, according to the control signal, the industrial camera to acquire the image of the to-be-sorted part, where the image includes an RGB image and a depth image.

In this step, after the task instruction understanding model deployed in the server obtains the control signal for controlling the robotic arm according to the part sorting description information, the industrial camera collects the image of the to-be-sorted part on the current industrial line in real time based on the control signal. The industrial camera can be arranged on the robotic arm in advance or around the robotic arm in advance to photograph the to-be-sorted part on the industrial line in real time and obtain the corresponding image. The type of the industrial camera is not limited, as long as the camera has the function of shooting RGB images and depth images.

Specifically, the image of the to-be-sorted part collected by the industrial camera includes the RGB image and the depth image. Among them, the RGB image is an image composed of three primary colors: red, green and blue. This image format is widely used in digital image processing, and is a color-based image representation. In the RGB image, each pixel is represented by values of three color channels. The depth image is called a range image, which refers to an image that takes a distance to each point in a scene from an image collector as a pixel value.

S702: input the RGB image and the depth image into the intelligent perception model for parts for performing feature analysis processing, to obtain the category and the grasp pose of the to-be-sorted part, where the intelligent perception model for parts includes a Transformer layer, a convolutional neural network layer and a fully connected layer.

In this step, after the industrial camera collects the image of the to-be-sorted part based on step S701, the corresponding image is transmitted to the intelligent perception model for parts deployed in the server in real time.

The intelligent perception model for parts takes the RGB image and the depth image corresponding to the to-be-sorted part collected by the industrial camera in real time as input, and takes the category and the grasp pose of the to-be-sorted part as output. Specifically, the intelligent perception model for parts is a neural network model, including the Transformer layer, the convolutional neural network layer and the fully connected layer.

Specifically, the Transformer layer is formed by two portions, namely, an encoder and a decoder. The encoder converts an input sequence into a series of context representation vectors. The encoder is formed by multiple identical layers, and each layer is formed by two sub-layers, namely, a self-attention layer and a feed-forward fully connected layer. The decoder takes the output of the encoder and a target sequence as input to generate a probability distribution of each position in the target sequence. The decoder is formed by multiple identical layers, and each layer is formed by three sub-layers, namely, a self-attention layer, an encoder-decoder attention layer and a feed-forward fully connected layer.

The basic structure of a convolutional neural network includes an input layer, a convolution layer, a pooling layer and an output layer. The input layer is a pixel matrix corresponding to the image of the to-be-sorted part collected by the industrial camera. The convolution layer is the core of the convolutional neural network, and can perform convolution calculation on the inputted data. The pooling layer will perform a pooling operation, that is, to take an overall statistical feature of adjacent regions of a certain position of the inputted pixel matrix as the output for that position. After several rounds of processing by the convolution layer and the pooling layer, the information in the image of the to-be-sorted part has been abstracted into features with higher information content, that is, the convolution layer and the pooling layer can be regarded as the process of image feature extraction. After the extraction is completed, the extracted image features are outputted.

The fully connected layer takes the output of the convolutional neural network layer as input, and synthesizes the extracted image features to obtain the category and the grasp pose of the to-be-sorted part.

After obtaining the category and the grasp pose of the to-be-sorted part, the robotic arm can determine whether to sort the part on the current industrial line based on the description information of the to-be-sorted parts involved in the control signal.

The embodied intelligence-based method for industrial part sorting processing provided by this embodiment is mainly to explain the input and output information of the intelligent perception model for parts. Among them, the input of the intelligent perception model for parts is the RGB image and the depth image corresponding to the to-be-sorted part collected by the industrial camera in real time according to the control signal, and the output is the category and the grasp pose of the to-be-sorted part. Based on the intelligent perception model for parts, the to-be-sorted part does not need to appear on the industrial line in the fixed pose, which is beneficial to the development and promotion of the intelligent flexible production line.

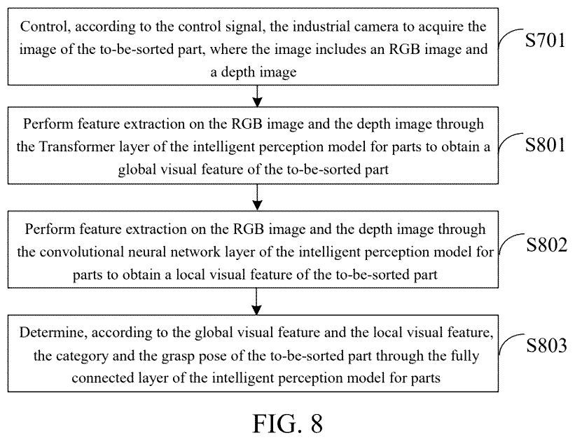

FIG. 8 is a schematic flowchart of a sixth embodiment of an embodied intelligence-based method for industrial part sorting processing provided by the present application. As shown in FIG. 8, on the basis of the above embodiments, the RGB image and the depth image are inputted into the intelligent perception model for parts for performing the feature analysis processing, to obtain the category and the grasp pose of the to-be-sorted part, and a procedure of the embodied intelligence-based method for industrial part sorting processing may include the following steps.

S801: perform feature extraction on the RGB image and the depth image through the Transformer layer of the intelligent perception model for parts to obtain a global visual feature of the to-be-sorted part.

In this step, the category and the pose of the to-be-sorted part are determined according to the intelligent perception model for parts. The intelligent perception model for parts includes the Transformer layer, the convolutional neural network layer and the fully connected layer.

When receiving the RGB image and the depth image corresponding to the to-be-sorted part, the intelligent perception model for parts extracts features from the RGB image and the depth image through the Transformer layer of the intelligent perception model for parts to obtain a global visual feature of the to-be-sorted part.

In the intelligent perception model for parts, an intelligent sorting algorithm combines two modules of part classification and grasping detection. The RGB image and the depth image of the to-be-sorted part are taken by this algorithm as two kinds of input of the intelligent perception model for parts respectively, and the two modules share common visual feature information of the to-be-sorted part in the deep learning model. After inputting the RGB image and depth image, the intelligent perception model for parts first uses an attention mechanism in the Transformer layer to extract the correlation between pixels in regions of image information, which helps the intelligent perception model for parts to pay more attention to regions related to a classification task and their features, thus improving the performance of part classification and grasping detection. This is helpful for the intelligent perception model for parts to deal with complex visual information more effectively. In addition, according to the attention mechanism, more important regions can be automatically selected and given higher parameter weights in a more efficient spatial selection way, and information irrelevant to part classification and grasping detection tasks can be suppressed at the same time, thus improving the overall robustness and accuracy of the model. After processing by the Transformer layer, the global visual feature of the to-be-sorted part can be obtained.

S802: perform feature extraction on the RGB image and the depth image through the convolutional neural network layer of the intelligent perception model for parts to obtain a local visual feature of the to-be-sorted part.

In this step, after the feature extraction is performed on the RGB image and the depth image through the Transformer layer of the intelligent perception model for parts to obtain the global visual feature of the to-be-sorted part based on step S801, the convolutional neural network in the intelligent perception model for parts is configured to perform feature extraction on the RGB image and the depth image to obtain the local visual feature of the to-be-sorted part.

After the global visual feature of the to-be-sorted part is obtained by using the Transformer layer in the intelligent perception model for parts, a local feature of the to-be-sorted part is extracted by using the convolutional neural network layer in the intelligent perception model for parts, and the computational complexity is reduced. Therefore, there are different feature extraction effects on different scales with different network depths, so that visual information of different scales can be better processed, which helps to classify and detect parts with different sizes and shapes. At the same time, parameters are shared by jumping connection between the two networks into which the RGB image and the depth image are inputted, and the association relationship between RGB and depth information at the same position in the image is reasonably utilized, thus obtaining more sufficient understanding ability.

In the grasping detection module, the visual features extracted by the intelligent perception model for parts are shared between the visual perception portion and the part classification module, and six-degree-of-freedom vector regression of grasping detection is realized in combination with the last few layers of networks of the intelligent perception model for parts.

S803: determine, according to the global visual feature and the local visual feature, the category and the grasp pose of the to-be-sorted part through the fully connected layer of the intelligent perception model for parts.

In this step, after the global visual feature of the to-be-sorted part is obtained based on step S801 and the local visual feature of the to-be-sorted part is obtained based on step S802, the category and the grasp pose of the to-be-sorted part are determined through the fully connected layer of the intelligent perception model for parts.

Based on the global visual feature and the local visual feature of the to-be-sorted part, the fully connected layer of the intelligent perception model for parts adopts a six-degree-of-freedom grasp pose as a target output, in order to detect multi-angle grasp poses of parts of different kinds, shapes and sizes at different angles in the whole three-dimensional space, so as to select the optimal poses for subsequent grasping.

The part classification module can classify different categories of parts. For example, the parts can be classified into “bearing”, “flange”, “actuator” and other categories according to their uses, and can be classified into “metal”, “glass”, “plastic” and other categories according to their materials, so as to facilitate the robotic arm to sort different categories of parts to different destinations subsequently. The grasping detection module can detect the grasp pose of the part when it is stationary on a table, which is convenient for the robotic arm to approach this pose with a certain motion trajectory and perform stable grasping, and the part will be transported to the target sorting destination by the robotic arm.

A loss function defined for the module that performs part classification in the intelligent perception model for parts is:

$$L ( y , \hat{y} ) = - {\sum }_{i = 1}^{N} {y}_{i} \cdot log ( {\hat{y}}_{i} )$$

where L(y, ŷ) refers to a loss function value, i is the i-th category corresponding to the to-be-sorted part, N is the number of categories of the part, yᵢ is an actual label, and ŷᵢ is a classification result outputted by a neural network involved in the part classification module of the intelligent perception model for parts. Assuming that there are N categories, the output of the neural network involved in the part classification module of the intelligent perception model for parts is an N-dimensional vector, which represents a probability distribution of each category, and the actual label is an N-dimensional coding vector.

Assuming that the grasp pose outputted by the intelligent perception model for parts is ĝ, and the actual grasp pose is g, then a loss function defined by the module that performs grasping detection in the intelligent perception model for parts is:

$$L ( \hat{g} , g ) = {\sum }_{i = 1}^{6} {( {\hat{g}}_{i} - {g}_{i} )}^{2}$$

where L(ĝ, g) is an attitude error loss value, i refers to the i-th six-degree-of-freedom grasp pose, ĝᵢ is a component of the i-th six-degree-of-freedom grasp pose predicted by the intelligent perception model for parts, and gᵢ is a component of the actual i-th six-degree-of-freedom grasp pose.

Based on the loss functions defined for the part classification module and the grasping detection module of the intelligent perception model for parts, a loss function of the whole intelligent perception model for parts is defined as:

$$L = 4 α \times L ( y , \hat{y} ) + β \times L ( \hat{g} , g )$$

where L refers to a loss function value defined for the intelligent perception model for parts, α and β are adjustment coefficients, the satisfied condition is α+β=1, L(y, ŷ) is the loss function value defined by the neural network involved in the part classification module of the intelligent perception model for parts, and L(ĝ, g) is the attitude error loss value defined by the neural network involved in the grasping detection module of the intelligent perception model for parts.

The embodied intelligence-based method for industrial part sorting processing provided by this embodiment is mainly to explain in detail how the modules involved in the intelligent perception model for parts realize the determination of categories and grasp poses of the parts. According to visual information, the intelligent perception model for parts classifies different parts according to their materials or uses, so that different parts can be sorted into different boxes. At the same time, a six-degree-of-freedom grasp detection algorithm is used to grasp and detect the parts on the assembly line, the grasp pose of a different part being taken as a destination target of each sorting action, so as to realize accurate and stable grasp of different parts at different positions and angles.

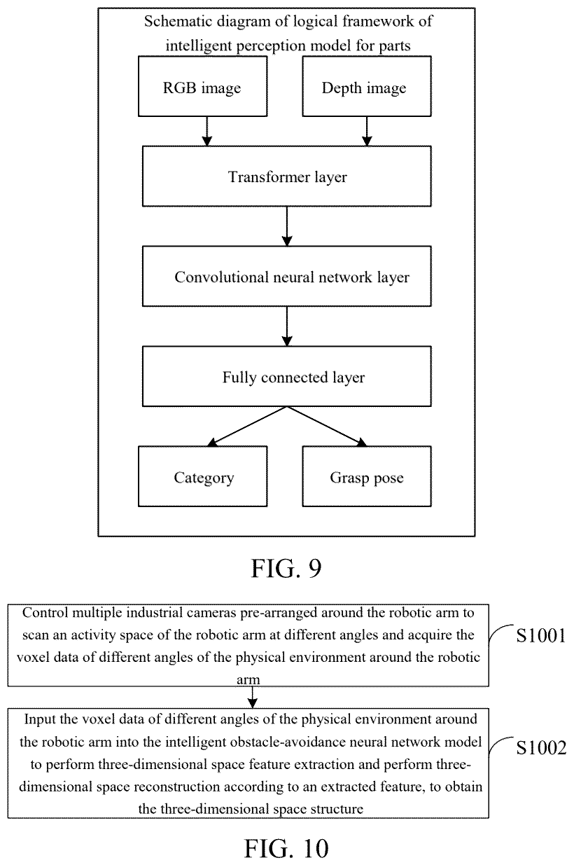

In one possible implementation, on the basis of any one of the above embodiments, FIG. 9 is a schematic diagram of a logical framework of an intelligent perception model for parts provided by the present application. As shown in FIG. 9, the intelligent perception model for parts takes an RGB image and a depth image of a to-be-sorted part as input, and the Transformer layer receives the inputted RGB image and depth image, and transmits processed data information to the convolutional neural network layer after processing. After processing by the neural network layer, a processing result is further transmitted to the fully connected layer. Under processing by the fully connected layer, the category and the grasp pose of the to-be-sorted part can be obtained as the output of the intelligent perception model for parts.

FIG. 10 is a schematic flowchart of a seventh embodiment of an embodied intelligence-based method for industrial part sorting processing provided by the present application. As shown in FIG. 10, on the basis of any one of the above embodiments, the voxel data of different angles of the physical environment around the robotic arm collected in real time by the industrial camera is processed by adopting the intelligent obstacle-avoidance neural network model, to obtain the three-dimensional spatial structure of the physical environment around the robotic arm, and a procedure of the embodied intelligence-based method for industrial part sorting processing may include the following steps.

S1001: control multiple industrial cameras pre-arranged around the robotic arm to scan an activity space of the robotic arm at different angles and acquire the voxel data of different angles of the physical environment around the robotic arm.

In this step, when the robotic arm sorts the to-be-sorted part according to the control signal, the category and the grasp pose of the to-be-sorted part, it is necessary to adopt the intelligent obstacle-avoidance neural network model to obtain the three-dimensional spatial structure of the physical environment around the robotic arm.

The input of the intelligent obstacle-avoidance neural network model is the voxel data of different angles of the physical environment around the robotic arm, and the voxel data is acquired according to multiple industrial cameras pre-arranged around the robotic arm. Specifically, multiple industrial cameras are pre-arranged around the robotic arm, and the activity space of the robotic arm is scanned at different angles in real time in the process of the robotic arm executing the part sorting task, so as to obtain the voxel data of different angles of the physical environment around the robotic arm.

S1002: input the voxel data of different angles of the physical environment around the robotic arm into the intelligent obstacle-avoidance neural network model to perform three-dimensional space feature extraction and perform three-dimensional space reconstruction according to an extracted feature to obtain the three-dimensional space structure.

In this step, after obtaining the voxel data of different angles of the physical environment around the robotic arm based on step S1001, all the obtained voxel data are inputted into the intelligent obstacle-avoidance neural network model in real time to perform the three-dimensional space feature extraction, and the three-dimensional space reconstruction is performed according to the extracted feature, to obtain the three-dimensional space structure of the environment around the robotic arm.

The three-dimensional spatial structure of the environment around the robotic arm acquired by the intelligent obstacle-avoidance neural network model is a spatial motion constraint of the robotic arm in the process of the robotic arm executing the part sorting task. Based on the spatial motion constraint and in combination with the robotic arm kinematics model, safe and reasonable motion trajectories of the robotic arm are planned, so that all parts can be effectively sorted to different target positions according to the part sorting requirement.

The embodied intelligence-based method for industrial part sorting processing provided by this embodiment is mainly to explain how the intelligent obstacle-avoidance neural network model obtains the three-dimensional spatial structure of the physical environment around the robotic arm. The intelligent obstacle-avoidance neural network model takes the multi-angle voxel data collected in real time by the industrial cameras as input, and after processing by the intelligent obstacle-avoidance neural network model, the three-dimensional spatial structure of the physical environment around the robotic arm at different angles is obtained. Through the acquired three-dimensional spatial structure, a constraint basis can be provided for planning the motion trajectory of the robotic arm, so as to plan a safe and reasonable motion trajectory of the robotic arm and ensure the safety of the robotic arm when executing the part sorting task.

In one possible embodiment, the intelligent obstacle-avoidance neural network model includes a three-dimensional convolution layer, an average pooling layer and a fully connected layer;
the three-dimensional convolution layer is configured to extract a global visual feature of a three-dimensional space from the voxel data of different physical environments around the robotic arm;
the average pooling layer is configured to reduce the size of a voxel grid in the three-dimensional space;
the fully connected layer is configured to reconstruct a grid model with the same size as the inputted voxel grid.

Specifically, in the process of the robotic arm executing the part sorting task, the applied intelligent obstacle-avoidance neural network model includes the three-dimensional convolution layer, the average pooling layer and the fully connected layer.

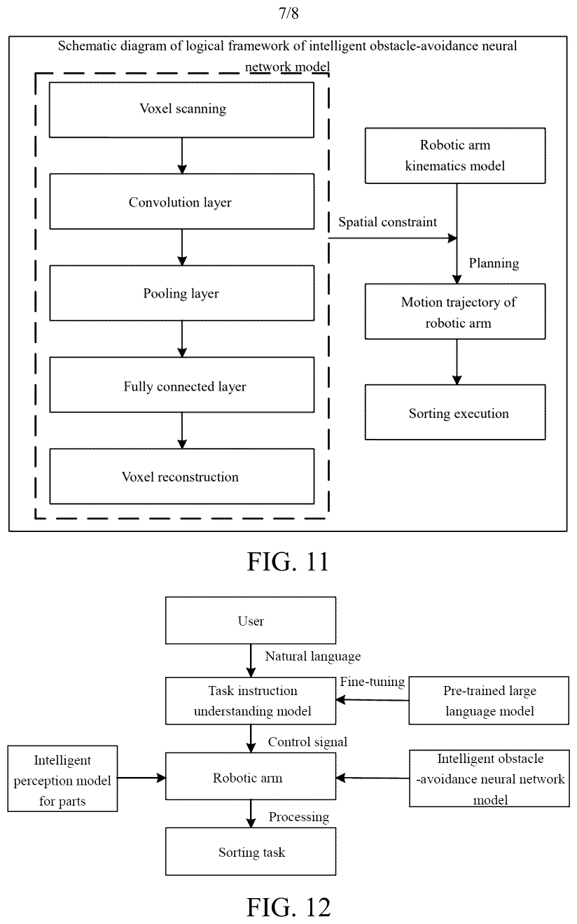

FIG. 11 is a schematic diagram of a logical framework of an intelligent obstacle-avoidance neural network model provided by the present application. As shown in FIG. 11, in the process of the robotic arm executing the part sorting task, the physical environment around the robotic arm is marked as a non-collision area after reconstruction through the vision-based dynamic three-dimensional reconstruction technology, which is used as a constraint of subsequent dynamic obstacle avoidance, and kinematic path planning of the robotic arm is performed under this constraint. Finally, all part sorting actions are performed, and all parts with different materials or different uses on a conveyor belt are sorted into different boxes in turn.

Specifically, the intelligent obstacle-avoidance neural network model adopts a method of deep learning. After taking the voxels scanned by the cameras as input data, firstly, the global visual feature of the three-dimensional space in the voxel data of different angles of the physical environment around the robotic arm is extracted using the three-dimensional convolution layer, and then the size of the voxel grid in the three-dimensional space is reduced through the average pooling layer, so as to reduce the amount of parameters of the network to make it more lightweight, which is convenient for deployment in industrial edge devices, and improve the processing speed of the intelligent obstacle-avoidance neural network model. At the same time, the perceptual field of vision of the intelligent obstacle-avoidance neural network model can be effectively increased to help the intelligent obstacle-avoidance neural network model capture a wider range of features. Finally, the grid model with the same size as the inputted voxel grid is reconstructed using the fully connected layer.

Based on the obtained network model and in combination with the robotic arm kinematics model, the motion trajectory of the robotic arm can be planned to assist the robotic arm in sorting.

When the intelligent obstacle-avoidance neural network model is pre-trained, a loss function is defined as:

$$L = 5 α \times L\_data + β \times L\_smooth$$

where α and β are adjustment coefficients, and the satisfied condition is α+β=1. L_data is used to measure a difference between the reconstructed three-dimensional spatial structure and an actual spatial structure, and a defined formula is:

$$L\_data = \sum {( \hat{v} - v )}^{2} / N$$

where N is the number of voxels, v is a label of a voxel, and \hat{v} is a voxel outputted by the intelligent obstacle-avoidance neural network model.

L_smooth is a regularization loss term, which is used to constrain the reconstructed three-dimensional spatial structure and make the outputted reconstruction effect smoother. A defined formula is:

$$L\_smooth = \sum {( ‖ ∇ \hat{v} ‖ )}^{2}$$

where ∇\hat{v} represents a gradient operation performed on the voxels outputted by the intelligent obstacle-avoidance neural network model.

In this embodiment, names and specific functions of the network layers involved in the intelligent obstacle-avoidance neural network model are mainly explained in detail. The intelligent obstacle-avoidance neural network model includes the three-dimensional convolution layer, the average pooling layer and the fully connected layer. These neural network layers are used to dynamically and intelligently reconstruct the surrounding three-dimensional physical environment when the robotic arm execute tasks, and then the robotic arm can move under the safe spatial constraint to ensure the safety when executing industrial tasks.

In one possible implementation, on the basis of any one of the above-mentioned embodiments, FIG. 12 is a schematic diagram of a framework of embodied intelligence-based industrial part sorting processing provided by the present application. As shown in FIG. 12, the framework of embodied intelligence-based industrial part sorting processing mainly includes the following processing models: the task instruction understanding model, the intelligent perception model for parts and the intelligent obstacle-avoidance neural network model. Firstly, the task instruction understanding model accurately extracts the instructions in the natural language inputted by the user through the strong natural language understanding ability of the large language model, which provides a basis for the subsequent control of the robotic arm. Secondly, after receiving the control signal outputted by the task instruction understanding model, the robotic arm first classifies different parts according to their materials, uses, etc., so that different parts can be sorted into different boxes. Then, the parts on the assembly line are grasped and detected through the intelligent perception model for parts, where the grasp pose of a different part is taken as the destination target of each sorting action. Finally, through the intelligent obstacle-avoidance neural network model, the physical environment around the robotic arm is marked as the non-collision area after reconstruction, which is used as the constraint of subsequent dynamic obstacle avoidance, and the kinematic path planning of the robotic arm is performed under this constraint. Finally, all sorting actions are performed, and all parts with different materials and/or different uses on the assembly line are sorted into different boxes in turn.

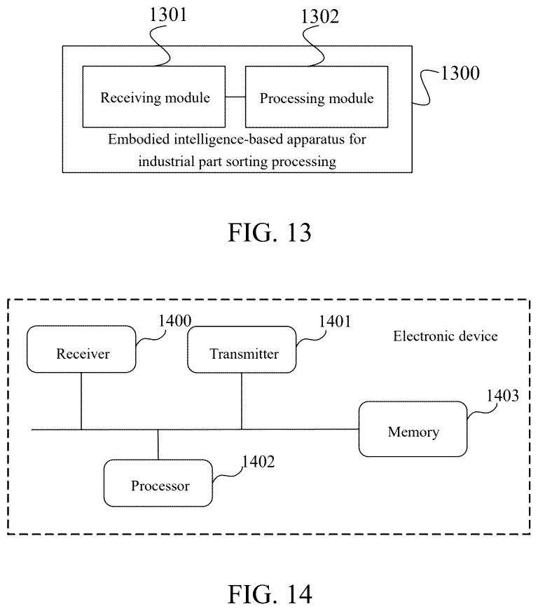

FIG. 13 is a schematic structural diagram of a first embodiment of an embodied intelligence-based apparatus for industrial part sorting processing provided by the present application. As shown in FIG. 13, the embodied intelligence-based apparatus 1300 for industrial part sorting processing includes:
a receiving module 1301, configured to receive part sorting description information inputted by a user, where the part sorting description information includes a feature description and a sorting requirement description of to-be-sorted parts;
a processing module 1302, configured to perform, according to the part sorting description information, analysis processing by adopting a task instruction understanding model, to obtain a control signal for controlling a robotic arm to sort the to-be-sorted parts, where the task instruction understanding model is a neural network model which is pre-trained based on a large language model for extracting a sorting requirement from text and generating a sorting control signal based on the sorting requirement;
where the processing module 1302 is further configured to perform, according to the control signal, analysis processing on an image of a to-be-sorted part by adopting a intelligent perception model for parts, to obtain a category and a grasp pose of the to-be-sorted part, where the image is collected by an industrial camera, and the intelligent perception model is a neural network model which is pre-trained for determining a category and a grasp pose of a part based on image recognition analysis;
the processing module 1302 is further configured to control the robotic arm to sort the to-be-sorted part according to the control signal, the category and the grasp pose of the to-be-sorted part, and perform obstacle-avoidance processing through an intelligent obstacle-avoidance neural network model in a sorting process.

In an implementation, the processing module 1302 is further configured to:
in the sorting process, process, by adopting the intelligent obstacle-avoidance neural network model, voxel data of different angles of physical environment around the robotic arm which is collected in real time by the industrial camera, to obtain a three-dimensional spatial structure of the physical environment around the robotic arm, where the intelligent obstacle-avoidance neural network model is a pre-trained intelligent model for performing dynamic three-dimensional reconstruction according to voxel data;
process the three-dimensional spatial structure by adopting a robotic arm kinematics model, to obtain a motion trajectory of the robotic arm.

In an implementation, the processing module 1302 is further configured to:
control, according to the control signal, the category and the grasp pose of the to-be-sorted part, the robotic arm to sort the to-be-sorted part following the motion trajectory of the robotic arm.

In an implementation, the processing module 1302 is further configured to:
perform understanding processing on the part sorting description information through a natural language understanding portion of the task instruction understanding model to obtain a feature and a sorting requirement of the to-be-sorted parts, and generate the control signal based on the feature and the sorting requirement of the to-be-sorted parts through a signal generation portion of the task instruction understanding model.

In an implementation, the processing module 1302 is further configured to:
control, according to the control signal, the industrial camera to acquire the image of the to-be-sorted part, where the image includes an RGB image and a depth image;
input the RGB image and the depth image into the intelligent perception model for parts for performing feature analysis processing, to obtain the category and the grasp pose of the to-be-sorted part;
where the intelligent perception model for parts includes a Transformer layer, a convolutional neural network layer and a fully connected layer.

In an implementation, the processing module 1302 is further configured to:
perform feature extraction on the RGB image and the depth image through the Transformer layer of the intelligent perception model for parts to obtain a global visual feature of the to-be-sorted part;
perform feature extraction on the RGB image and the depth image through the convolutional neural network layer of the intelligent perception model for parts to obtain a local visual feature of the to-be-sorted part;
determine, according to the global visual feature and the local visual feature, the category and the grasp pose of the to-be-sorted part through the fully connected layer of the intelligent perception model for parts.

In an implementation, the processing module 1302 is further configured to:
control multiple industrial cameras pre-arranged around the robotic arm to scan an activity space of the robotic arm at different angles and acquire the voxel data of different angles of the physical environment around the robotic arm;
input the voxel data of different angles of the physical environment around the robotic arm into the intelligent obstacle-avoidance neural network model to perform three-dimensional space feature extraction and perform three-dimensional space reconstruction according to an extracted feature, to obtain the three-dimensional space structure.

In an implementation, the intelligent obstacle-avoidance neural network model includes a three-dimensional convolution layer, an average pooling layer and a fully connected layer;
where the three-dimensional convolution layer is configured to extract a global visual feature of a three-dimensional space from the voxel data of different angles of the physical environment around the robotic arm;
the average pooling layer is configured to reduce a size of a voxel grid in the three-dimensional space;
the fully connected layer is configured to reconstruct a grid model with a same size as an inputted voxel grid.

The embodied intelligence-based apparatus for industrial part sorting processing provided by this embodiment can be used to execute the embodied intelligence-based method for industrial part sorting processing in any one of the above method embodiments. Implementation principles and technical effects thereof are similar, so the details are not repeated here.

FIG. 14 is a schematic structural diagram of an embodied intelligence-based electronic device for industrial part sorting processing provided by the present application. As shown in FIG. 14, the electronic device may specifically include a receiver 1400, a transmitter 1401, a processor 1402 and a memory 1403. The receiver 1400 and the transmitter 1401 are configured to realize data transmission between the electronic device and a terminal, and the memory 1403 stores computer-executed instructions. The processor 1402 executes the computer-executed instructions stored in the memory 1403, to implement the embodied intelligence-based method for industrial part sorting processing in the above embodiments.

An embodiment of the present application also provides a computer-readable storage medium, where computer-execution instructions are stored in the computer-readable storage medium, and when the computer-execution instructions are executed by a processor, the embodied intelligence-based method for industrial part sorting processing in the above embodiments is implemented.

An embodiment of the present application also provides a computer program product, including a computer program, and when the computer program is executed by a processor, the embodied intelligence-based method for industrial part sorting processing provided by any one of the above embodiments is implemented.

Other embodiments of the present application will easily occur to those skilled in the art after considering the specification and practicing the disclosure disclosed herein. The present application is intended to cover any variations, uses or adaptations of the present application, which follow the general principles of the present application and include common knowledge or conventional technical means in this technical field that are not disclosed in the present application. The specification and examples are to be regarded as exemplary only, with the true scope and spirit of the present application being indicated by the following claims.

It should be understood that the present application is not limited to the precise structure described above and shown in the drawings, and various modifications and changes can be made without departing from its scope. The scope of the present application is limited only by the appended claims.

What is claimed is:

1. An embodied intelligence-based method for industrial part sorting processing, comprising:
receiving part sorting description information inputted by a user, wherein the part sorting description information comprises a feature description and a sorting requirement description of to-be-sorted parts;
performing, according to the part sorting description information, analysis processing by adopting a task instruction understanding model, to obtain a control signal for controlling a robotic arm to sort the to-be-sorted parts, wherein the task instruction understanding model is a neural network model which is pre-trained based on a large language model for extracting a sorting requirement from text and generating a sorting control signal based on the sorting requirement;
performing, according to the control signal, analysis processing on an image of a to-be-sorted part by adopting an intelligent perception model for parts, to obtain a category and a grasp pose of the to-be-sorted part, wherein the image is collected by an industrial camera, and the intelligent perception model for parts is a neural network model which is pre-trained for determining a category and a grasp pose of a part based on image recognition analysis;
controlling the robotic arm to sort the to-be-sorted part according to the control signal, the category and the grasp pose of the to-be-sorted part, and performing obstacle-avoidance processing through an intelligent obstacle-avoidance neural network model in a sorting process.

2. The method according to claim 1, wherein performing the obstacle-avoidance processing through the intelligent obstacle-avoidance neural network model in the sorting process comprises:
in the sorting process, processing, by adopting the intelligent obstacle-avoidance neural network model, voxel data of different angles of physical environment around the robotic arm which is collected in real time by the industrial camera, to obtain a three-dimensional spatial structure of the physical environment around the robotic arm, wherein the intelligent obstacle-avoidance neural network model is a pre-trained intelligent model for performing dynamic three-dimensional reconstruction according to voxel data;
processing the three-dimensional spatial structure by adopting a robotic arm kinematics model, to obtain a motion trajectory of the robotic arm;
correspondingly, controlling the robotic arm to sort the to-be-sorted part according to the control signal, the category and the grasp pose of the to-be-sorted part comprises:
controlling, according to the control signal, the category and the grasp pose of the to-be-sorted part, the robotic arm to sort the to-be-sorted part following the motion trajectory of the robotic arm.

3. The method according to claim 1, wherein performing, according to the part sorting description information, the analysis processing by adopting the task instruction understanding model, to obtain the control signal for controlling the robotic arm to sort the to-be-sorted parts comprises:
performing understanding processing on the part sorting description information through a natural language understanding portion of the task instruction understanding model to obtain a feature and a sorting requirement of the to-be-sorted parts, and generating the control signal based on the feature and the sorting requirement of the to-be-sorted parts through a signal generation portion of the task instruction understanding model.

4. The method according to claim 1, wherein performing, according to the control signal, the analysis processing on the image of the to-be-sorted part by adopting the intelligent perception model for parts, to obtain the category and the grasp pose of the to-be-sorted part, wherein the image is collected by the industrial camera, comprises:
controlling, according to the control signal, the industrial camera to acquire the image of the to-be-sorted part, wherein the image comprises an RGB image and a depth image;
inputting the RGB image and the depth image into the intelligent perception model for parts for performing feature analysis processing, to obtain the category and the grasp pose of the to-be-sorted part;
wherein the intelligent perception model for parts comprises a Transformer layer, a convolutional neural network layer and a fully connected layer.

5. The method according to claim 4, wherein inputting the RGB image and the depth image into the intelligent perception model for parts for performing the feature analysis processing, to obtain the category and the grasp pose of the to-be-sorted part comprises:
performing feature extraction on the RGB image and the depth image through the Transformer layer of the intelligent perception model for parts to obtain a global visual feature of the to-be-sorted part;
performing feature extraction on the RGB image and the depth image through the convolutional neural network layer of the intelligent perception model for parts to obtain a local visual feature of the to-be-sorted part;
determining, according to the global visual feature and the local visual feature, the category and the grasp pose of the to-be-sorted part through the fully connected layer of the intelligent perception model for parts.

6. The method according to claim 2, wherein in the sorting process, processing, by adopting the intelligent obstacle-avoidance neural network model, the voxel data of different angles of the physical environment around the robotic arm which is collected in real time by the industrial camera, to obtain the three-dimensional spatial structure of the physical environment around the robotic arm comprises:
controlling multiple industrial cameras pre-arranged around the robotic arm to scan an activity space of the robotic arm at different angles and acquire the voxel data of different angles of the physical environment around the robotic arm;
inputting the voxel data of different angles of the physical environment around the robotic arm into the intelligent obstacle-avoidance neural network model to perform three-dimensional space feature extraction and perform three-dimensional space reconstruction according to an extracted feature, to obtain the three-dimensional space structure.

7. The method according to claim 6, wherein the intelligent obstacle-avoidance neural network model comprises a three-dimensional convolution layer, an average pooling layer and a fully connected layer;
wherein the three-dimensional convolution layer is configured to extract a global visual feature of a three-dimensional space from the voxel data of different angles of the physical environment around the robotic arm;
the average pooling layer is configured to reduce a size of a voxel grid in the three-dimensional space;
the fully connected layer is configured to reconstruct a grid model with a same size as an inputted voxel grid.

8. An electronic device, comprising: a processor and a memory communicatively connected with the processor;
wherein the memory stores computer-executed instructions;
the processor executes the computer-executed instructions stored in the memory to:
receive part sorting description information inputted by a user, wherein the part sorting description information comprises a feature description and a sorting requirement description of to-be-sorted parts;
perform, according to the part sorting description information, analysis processing by adopting a task instruction understanding model, to obtain a control signal for controlling a robotic arm to sort the to-be-sorted parts, wherein the task instruction understanding model is a neural network model which is pre-trained based on a large language model for extracting a sorting requirement from text and generating a sorting control signal based on the sorting requirement;
perform, according to the control signal, analysis processing on an image of a to-be-sorted part by adopting an intelligent perception model for parts, to obtain a category and a grasp pose of the to-be-sorted part, wherein the image is collected by an industrial camera, and the intelligent perception model is a neural network model which is pre-trained for determining a category and a grasp pose of a part based on image recognition analysis;
control the robotic arm to sort the to-be-sorted part according to the control signal, the category and the grasp pose of the to-be-sorted part, and perform obstacle-avoidance processing through an intelligent obstacle-avoidance neural network model in a sorting process.

9. The electronic device according to claim 8, wherein the processor is further configured to:
in the sorting process, process, by adopting the intelligent obstacle-avoidance neural network model, voxel data of different angles of physical environment around the robotic arm which is collected in real time by the industrial camera, to obtain a three-dimensional spatial structure of the physical environment around the robotic arm, wherein the intelligent obstacle-avoidance neural network model is a pre-trained intelligent model for performing dynamic three-dimensional reconstruction according to voxel data;
process the three-dimensional spatial structure by adopting a robotic arm kinematics model, to obtain a motion trajectory of the robotic arm;
wherein the processor is further configured to:
control, according to the control signal, the category and the grasp pose of the to-be-sorted part, the robotic arm to sort the to-be-sorted part following the motion trajectory of the robotic arm.

10. The electronic device according to claim 8, wherein the processor is further configured to:
perform understanding processing on the part sorting description information through a natural language understanding portion of the task instruction understanding model to obtain a feature and a sorting requirement of the to-be-sorted parts, and generate the control signal based on the feature and the sorting requirement of the to-be-sorted parts through a signal generation portion of the task instruction understanding model.

11. The electronic device according to claim 8, wherein the processor is further configured to:
control, according to the control signal, the industrial camera to acquire the image of the to-be-sorted part, wherein the image comprises an RGB image and a depth image;
input the RGB image and the depth image into the intelligent perception model for parts for performing feature analysis processing, to obtain the category and the grasp pose of the to-be-sorted part;
wherein the intelligent perception model for parts comprises a Transformer layer, a convolutional neural network layer and a fully connected layer.

12. The electronic device according to claim 11, wherein the processor is further configured to:
perform feature extraction on the RGB image and the depth image through the Transformer layer of the intelligent perception model for parts to obtain a global visual feature of the to-be-sorted part;
perform feature extraction on the RGB image and the depth image through the convolutional neural network layer of the intelligent perception model for parts to obtain a local visual feature of the to-be-sorted part;
determine, according to the global visual feature and the local visual feature, the category and the grasp pose of the to-be-sorted part through the fully connected layer of the intelligent perception model for parts.

13. The electronic device according to claim 9, wherein the processor is further configured to:
control multiple industrial cameras pre-arranged around the robotic arm to scan an activity space of the robotic arm at different angles and acquire the voxel data of different angles of the physical environment around the robotic arm;
input the voxel data of different angles of the physical environment around the robotic arm into the intelligent obstacle-avoidance neural network model to perform three-dimensional space feature extraction and perform three-dimensional space reconstruction according to an extracted feature, to obtain the three-dimensional space structure.

14. The electronic device according to claim 13, wherein the intelligent obstacle-avoidance neural network model comprises a three-dimensional convolution layer, an average pooling layer and a fully connected layer;
wherein the three-dimensional convolution layer is configured to extract a global visual feature of a three-dimensional space from the voxel data of different angles of the physical environment around the robotic arm;
the average pooling layer is configured to reduce a size of a voxel grid in the three-dimensional space;
the fully connected layer is configured to reconstruct a grid model with a same size as an inputted voxel grid.

15. A non-transitory computer-readable storage medium, wherein computer-executed instructions are stored in the non-transitory computer-readable storage medium, and when the computer-executed instructions are executed by a processor, the following operations are implemented:
receiving part sorting description information inputted by a user, wherein the part sorting description information comprises a feature description and a sorting requirement description of to-be-sorted parts;
performing, according to the part sorting description information, analysis processing by adopting a task instruction understanding model, to obtain a control signal for controlling a robotic arm to sort the to-be-sorted parts, wherein the task instruction understanding model is a neural network model which is pre-trained based on a large language model for extracting a sorting requirement from text and generating a sorting control signal based on the sorting requirement;
performing, according to the control signal, analysis processing on an image of a to-be-sorted part by adopting an intelligent perception model for parts, to obtain a category and a grasp pose of the to-be-sorted part, wherein the image is collected by an industrial camera, and the intelligent perception model is a neural network model which is pre-trained for determining a category and a grasp pose of a part based on image recognition analysis;
controlling the robotic arm to sort the to-be-sorted part according to the control signal, the category and the grasp pose of the to-be-sorted part, and performing obstacle-avoidance processing through an intelligent obstacle-avoidance neural network model in a sorting process.

16. The non-transitory computer-readable storage medium according to claim 15, wherein performing the obstacle-avoidance processing through the intelligent obstacle-avoidance neural network model in the sorting process comprises:
in the sorting process, processing, by adopting the intelligent obstacle-avoidance neural network model, voxel data of different angles of physical environment around the robotic arm which is collected in real time by the industrial camera, to obtain a three-dimensional spatial structure of the physical environment around the robotic arm, wherein the intelligent obstacle-avoidance neural network model is a pre-trained intelligent model for performing dynamic three-dimensional reconstruction according to voxel data;
processing the three-dimensional spatial structure by adopting a robotic arm kinematics model, to obtain a motion trajectory of the robotic arm;
correspondingly, controlling the robotic arm to sort the to-be-sorted part according to the control signal, the category and the grasp pose of the to-be-sorted part comprises:
controlling, according to the control signal, the category and the grasp pose of the to-be-sorted part, the robotic arm to sort the to-be-sorted part following the motion trajectory of the robotic arm.

17. The non-transitory computer-readable storage medium according to claim 15, wherein performing, according to the part sorting description information, the analysis processing by adopting the task instruction understanding model, to obtain the control signal for controlling the robotic arm to sort the to-be-sorted parts comprises:
performing understanding processing on the part sorting description information through a natural language understanding portion of the task instruction understanding model to obtain a feature and a sorting requirement of the to-be-sorted parts, and generating the control signal based on the feature and the sorting requirement of the to-be-sorted parts through a signal generation portion of the task instruction understanding model.

18. The non-transitory computer-readable storage medium according to claim 15, wherein performing, according to the control signal, the analysis processing on the image of the to-be-sorted part by adopting the intelligent perception model for parts, to obtain the category and the grasp pose of the to-be-sorted part, wherein the image is collected by the industrial camera, comprises:
controlling, according to the control signal, the industrial camera to acquire the image of the to-be-sorted part, wherein the image comprises an RGB image and a depth image;
inputting the RGB image and the depth image into the intelligent perception model for parts for performing feature analysis processing, to obtain the category and the grasp pose of the to-be-sorted part;
wherein the intelligent perception model for parts comprises a Transformer layer, a convolutional neural network layer and a fully connected layer.

19. The non-transitory computer-readable storage medium according to claim 18, wherein inputting the RGB image and the depth image into the intelligent perception model for parts for performing the feature analysis processing, to obtain the category and the grasp pose of the to-be-sorted part comprises:
performing feature extraction on the RGB image and the depth image through the Transformer layer of the intelligent perception model for parts to obtain a global visual feature of the to-be-sorted part;
performing feature extraction on the RGB image and the depth image through the convolutional neural network layer of the intelligent perception model for parts to obtain a local visual feature of the to-be-sorted part;
determining, according to the global visual feature and the local visual feature, the category and the grasp pose of the to-be-sorted part through the fully connected layer of the intelligent perception model for parts.

20. The non-transitory computer-readable storage medium according to claim 16, wherein in the sorting process, processing, by adopting the intelligent obstacle-avoidance neural network model, the voxel data of different angles of the physical environment around the robotic arm which is collected in real time by the industrial camera, to obtain the three-dimensional spatial structure of the physical environment around the robotic arm comprises:
controlling multiple industrial cameras pre-arranged around the robotic arm to scan an activity space of the robotic arm at different angles and acquire the voxel data of different angles of the physical environment around the robotic arm;
inputting the voxel data of different angles of the physical environment around the robotic arm into the intelligent obstacle-avoidance neural network model to perform three-dimensional space feature extraction and perform three-dimensional space reconstruction according to an extracted feature, to obtain the three-dimensional space structure.
